(19) United States
(12) Patent Application Publication
(10) Pub. No.: US 2025/0169541 A1
(43) Pub. Date: May 29, 2025

(54) HEATING ELEMENT AND ELECTRONIC ATOMIZATION DEVICE

(71) Applicant: SHENZHEN SMOORE TECHNOLOGY LIMITED, Shenzhen (CN)

(72) Inventors: He JIN, Shenzhen (CN); Hongming ZHOU, Shenzhen (CN); Jinxing DENG, Shenzhen (CN); Xianwu DU, Shenzhen (CN); Rihong LI, Shenzhen (CN)

(21) Appl. No.: 19/037,538

(22) Filed: Jan. 27, 2025

Related U.S. Application Data
(63) Continuation of application No. PCT/CN2023/095929, filed on May 24, 2023.

(30) Foreign Application Priority Data
Jul. 29, 2022 (CN) 202210910721.0

(51) Int. Cl. A24F 40/465; A24F 40/485; A24F 40/51; A24F 40/70

(52) U.S. Cl. CPC A24F 40/465; A24F 40/485; A24F 40/51; A24F 40/70

(57) ABSTRACT

A heating element includes: a substrate including a metal material; and a protective layer directly and completely wrapping a surface of the substrate so as to prevent a heavy metal element in the substrate from being separated out. In an embodiment, the heating element includes: a functional film layer. The protective layer is arranged between the functional film layer and the substrate. The functional film layer includes at least one of a heat-equalizing layer, a heating film layer, an infrared radiation film layer, and a temperature-measuring layer.

### CROSS-REFERENCE TO PRIOR APPLICATION

This application is a continuation of International Patent Application No. PCT/CN2023/095929, filed on May 24, 2023, which claims priority to Chinese Patent Application No. 202210910721.0, filed on Jul. 29, 2022. The entire disclosure of both applications is hereby incorporated by reference herein.

### FIELD

The present application relates to the technical field of atomization, and in particular, to a heating element and an electronic atomization device.

### BACKGROUND

An aerosol is a colloidal dispersion system formed by dispersing small solid or liquid particles in a gas medium, and may be absorbed by a human body through a respiratory system, thereby providing a novel alternative absorption mode for a user. For example, an electronic atomization device capable of generating an aerosol by baking and heating a herbal or paste aerosol-forming medium is used in different fields, delivers an inhalable aerosol to a user, and replaces conventional product forms and absorption modes.

The electronic atomization device heats the aerosol-forming medium by using a heating element so as to produce the aerosol for the user to inhale. The heating element includes a substrate. In order to avoid the heating element from being broken or cracked, more and more heating elements currently use metal materials to form substrates thereof. However, since the metal materials forming the substrates of the heating elements mostly contain heavy metal elements such as nickel and chromium. The separating-out of the heavy metal elements affects the safety of the aerosol, thereby bringing potential safety hazards to human health.

### SUMMARY

In an embodiment, the present invention provides a heating element, comprising: a substrate comprising a metal material; and a protective layer directly and completely wrapping a surface of the substrate so as to prevent a heavy metal element in the substrate from being separated out.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a structure diagram of a heating element provided by an embodiment of the present application;

FIG. 2 is a partial structure diagram of the heating element shown in FIG. 1;

FIG. 3 is a structure diagram of a heating element provided by another embodiment of the present application;

FIG. 4 is a structure diagram of a heating element provided by another embodiment of the present application;

FIG. 5 is a partial structure diagram of a heating element according to one more embodiment of the present application;

FIG. 6 is a partial structure diagram of a heating element according to another embodiment of the present application;

FIG. 7 is a partial structure diagram of a heating element according to one more embodiment of the present application;

FIG. 8 is a partial structure diagram of a heating element according to one more embodiment of the present application; and

FIG. 9 is a ternary phase diagram of BaO-Al2O3-SiO2.

### DETAILED DESCRIPTION

In an embodiment, the present invention provides a heating element and an electronic atomization device.

A heating element is provided and the heating element includes:
a substrate, wherein the substrate is prepared from a metal material; and
a protective layer directly and completely wrapping a surface of the substrate so as to prevent a heavy metal element in the substrate from being separated out. In one embodiment, the heating element further includes a functional film layer, and the protective layer is arranged between the functional film layer and
the substrate.

The functional film layer includes one or more of a heat-equalizing layer, a heating film layer, an infrared radiation film layer and a temperature-measuring layer.

In one embodiment, the heating film layer includes a first film belt and a heating circuit arranged on the first film belt.

In one embodiment, the temperature-measuring layer includes a second film belt and a temperature-measuring circuit arranged on the second film belt.

In one embodiment, the substrate is of a cylindrical heating structure, the substrate is provided with a containing position for containing an aerosol-forming medium, and the protective layer is arranged on the inner surface and the outer surface of the substrate; and the functional film layer includes the heat-equalizing layer and the heating film layer, the heat-equalizing layer and the heating film layer are both arranged outside the substrate, and the heat-equalizing layer is arranged at least a part between the heating film layer and the protective layer.

In one embodiment, the functional film layer further includes the infrared radiation film layer, and the infrared radiation film layer is arranged in the substrate.

In one embodiment, the substrate is of a cylindrical heating structure, the substrate is provided with a containing position for containing an aerosol-forming medium, and the protective layer is arranged on the inner surface and the outer surface of the substrate; and the functional film layer includes the temperature-measuring layer, and the temperature-measuring layer is arranged outside the substrate.

In one embodiment, the protective layer is prepared by using a dip-coating process.

In one embodiment, the thickness of the protective layer is 5 μm-200 μm.

In one embodiment, the substrate is prepared from 430 stainless steel, 316L stainless steel or 304 stainless steel. In one embodiment, the substrate is of a central heating structure, and the protective layer is arranged on the outer surface of the substrate;
or
the substrate is of a peripheral heating structure, the protective layer is arranged on the inner surface and the outer surface of the substrate, and the substrate is provided with a containing position for containing an aerosol-forming medium.

In one embodiment, the substrate is in a pin-shaped structure or a sheet-shaped structure; or
the substrate is of a circular tube structure with two open ends, or a cylindrical structure with an open top end and a closed bottom end.

In one embodiment, the substrate is of a hollow central heating structure with an open end and a closed end, vent holes are formed in the substrate, the vent holes are close to the closed end of the substrate, and the vent holes enable the hollow part of the substrate to communicate with an external space to form an airflow channel.

In one embodiment, the substrate includes a top part and a body, the body is of a hollow structure with two open ends, the top part is connected with one end of the body in a sealing manner and shields an opening of the end of the body, and the vent holes are formed in the body and close to the top part.

In one embodiment, the body is of a cylindrical structure, and the top part is gradually reduced towards the direction far away from the body.

In one embodiment, the substrate is capable of induction heating in a magnetic field.

The electronic atomization device includes a heating chamber and the heating element of any one of the above, wherein the heat element is arranged in the heating chamber and the heating chamber is used for containing an aerosol-forming medium.

The heating element and the electronic atomization device are provided. On the one hand, since the protective layer is directly arranged on the surface of the substrate and completely wraps the surface of the substrate, the separating-out of the heavy metal element in the substrate may be prevented in an all-round manner. Since the heavy metal element is not separated from the substrate, the safety of an aerosol formed by heating the heavy metal element is guaranteed, such that the human health is protected. On the other hand, the arrangement of the protective layer does not affect the performances of other functional film layers and the protective layer may be continuously coated. Besides, since the protective layer is directly arranged on the surface of the substrate, other functional film layers of the heating element must be arranged outside the protective layer, thereby avoiding making the salt fog-resistant ability of the heating element weaken greatly by directly coating the functional film layers on the surface of the substrate through high-temperature sintering (the high-temperature sintering is needed when the surface of the substrate is coated, but the protective layer on the surface of the substrate is damaged by a high-temperature heat treatment, an oxide layer is generated, and the corrosion is accelerated in a salt fog environment).
100: heating element; 10: substrate; 11: vent hole; 12: top part; 13: body; 20: protective layer; 30: heating film layer; 31: first film belt; 32: heating circuit; 40: heat-equalizing layer; 50: infrared radiation film layer; 60: temperature-measuring layer; 61: second film belt; and 62: temperature-measuring circuit.

To make the above objectives, features, and advantages of the present application more apparent and comprehensible, specific implementations of the present application are described in detail below with reference to drawings. In the following description, many specific details are described for thorough understanding of the present application. However, the present application may be implemented in many other manners different from those described herein. A person skilled in the art may make similar improvements without departing from the connotation of the present application. Therefore, the present application is not limited to the specific embodiments disclosed below.

In the description of the present application, it should be understood that orientation or position relationships indicated by terms such as “center”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise”, “anticlockwise”, “axial direction”, “radial direction”, and “circumferential direction” are based on orientation or position relationships shown in the drawings, and are merely used for ease and brevity of description of the present application, rather than indicating or implying that the mentioned device or element needs to have a particular orientation or be constructed and operated in a particular orientation. Therefore, such terms should not be construed as a limitation on the present application.

In addition, terms “first” and “second” are used merely for the purpose of description, and shall not be construed as indicating or implying relative importance or implying a quantity of indicated technical features. Therefore, a feature restricted by “first” or “second” may explicitly indicate or implicitly include at least one of such features. In description of the present application, “multiple” means at least two, such as two and three unless it is specifically defined otherwise.

In this application, unless otherwise explicitly specified or defined, the terms such as “install”, “connect”, “connection”, and “fix” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two elements or mutual action relationship between two elements, unless otherwise specified explicitly. A person of ordinary skill in the art may understand the specific meanings of the foregoing terms in the present application according to specific situations.

In the present application, unless otherwise explicitly specified and defined, a first feature being “on” or “under” a second feature may mean that the first feature is in direct contact with the second feature, or the first feature is in indirect contact with the second feature by using an intermediate medium. In addition, that the first feature is “above”, “over”, or “on” the second feature may indicate that the first feature is directly above or obliquely above the second feature, or may merely indicate that the horizontal position of the first feature is higher than that of the second feature. That the first feature is “below”, “under”, and “beneath” the second feature may be that the first feature is right below the second feature or at an inclined bottom of the second feature, or may merely indicate that the horizontal position of the first feature is lower than that of the second feature.

It should be noted that, when an element is referred to as “being fixed to” or “being arranged on” another element, the element may be directly located on the another element, or an intermediate element may exist. When an element is considered to be “connected to” another element, the element may be directly connected to the another element, or an intermediate element may exist. The terms “vertical”, “horizontal”, “up”, “down”, “left”, “right”, and similar expressions used herein are merely used for illustration and do not indicate a unique implementation.

An embodiment of the present application provides an electronic atomization device. The electronic atomization device includes a heating element 100, and the heating element 100 is used to heat an aerosol-forming medium so as to enable the aerosol-forming medium to volatilize corresponding components to form aerosol by heating and baking. When a user smokes the electronic atomization device or the aerosol-forming medium, a smoking airflow is generated and the generated aerosol follows the smoking airflow into the user's mouth, i.e. is inhaled by the user.

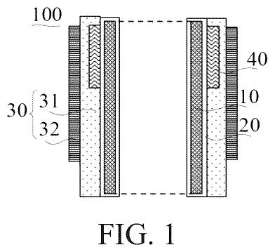

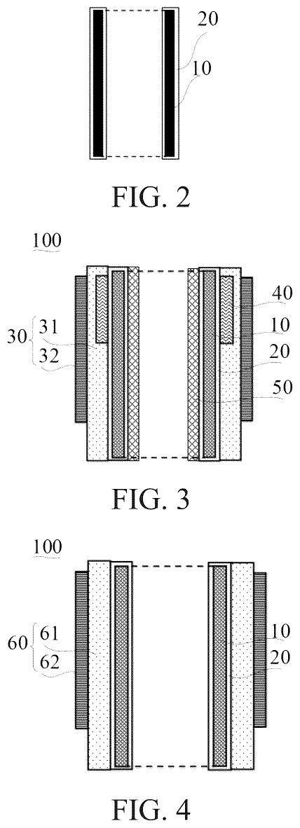

Referring to FIG. 1 and FIG. 2, a heating element 100 includes a substrate 10 and a protective layer 20. The substrate 10 is prepared from a metal material so as to avoid breaking or cracking of the substrate 10 prepared from other materials (such as ceramic). Specifically, the substrate 10 is prepared from 430 stainless steel, 316L stainless steel or 304 stainless steel.

The 430 stainless steel is a general steel type with good corrosion resistance, has better heat conductivity than austenite, smaller thermal expansion coefficient than the austenite, resists thermal fatigue, contains a stabilizing element titanium and has good mechanical property at welding seam parts. The 316L is widely applied in the chemical industry due to the excellent corrosion resistance, is also a derivative steel type belonging to 18-8 type austenitic stainless steel, and contains 2-3% of a Mo element. The 304 stainless steel is a common material in stainless steel, also called 18/8 stainless steel in the industry (meaning contains 18% or more of chromium and 8% or more of nickel), resists the high temperature of 800° C., and has the characteristics of good processability and high toughness.

It should be understood that in some other embodiments, the type of the metal material used in the substrate 10 is not limited.

The protective layer 20 directly and completely wraps the surface of the substrate 10 so as to prevent a heavy metal element in the substrate 10 from being separated out. That is there is no other layer structures existing between the protective layer 20 and the substrate 10. The protective layer 20 directly and completely wraps the surface of the substrate (10) so as to prevent the heavy metal element in the substrate (10) from being separated out. The complete wrapping means that: the protective layer 20 completely wraps the surface (including the inner surface and the outer surface) of the substrate 10 exposed to the outside.

On the one hand, since the protective layer 20 is directly arranged on the surface of the substrate 10 and completely wraps the surface of the substrate 10, the separating-out of the heavy metal element in the substrate 10 may be prevented in an all-round manner. Since the heavy metal element is not separated from the substrate 10, the safety of an aerosol formed by heating the heavy metal element is guaranteed, such that the human health is protected. On the other hand, the arrangement of the protective layer 20 does not affect the performances of other functional film layers and the protective layer may be continuously coated. Besides, since the protective layer 20 is directly arranged on the surface of the substrate 10, other functional film layers of the heating element 100 must be arranged outside the protective layer 20, thereby avoiding making the salt fog-resistant ability of the heating element 100 weaken greatly by directly coating the functional film layers on the surface of the substrate 10 through high-temperature sintering (the high-temperature sintering is needed when the surface of the substrate 10 is coated, but the protective layer on the surface of the substrate 10 is damaged by a high-temperature heat treatment, an oxide layer is generated, and the corrosion is accelerated in a salt fog environment).

In some embodiments, referring to FIG. 3-FIG. 5, the substrate 10 is of a peripheral heating structure, the protective layer 20 is arranged on the inner surface and the outer surface of the substrate 10 so as to wrap the surface of the whole substrate 10, and the substrate 10 is provided with a containing position for containing an aerosol-forming medium.

When the aerosol-forming medium is heated, the aerosol-forming medium is inserted into the containing position and the heating element 100 heats up to bake the aerosol-forming medium located in the containing position.

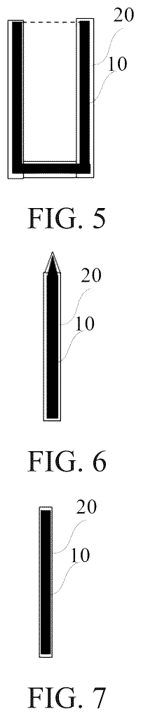

The substrate 10 is of a circular tube structure with two open ends, that is, the substrate 10 has a hollow cavity and the hollow cavity penetrates the substrate 10 in an axial direction and forms the containing position. Referring to FIG. 5, it is contemplated that in some other specific embodiments, the substrate 10 may also be arranged to be a cylindrical structure with an open top end and a closed bottom end, that is, one end of the hollow cavity is closed and the other end forms an opening for inserting the aerosol-forming medium.

In another embodiment, referring to FIG. 6 and FIG. 7, the substrate 10 is of a central heating structure, the protective layer 20 is arranged on the outer surface of the substrate 10. When the aerosol-forming medium is heated, the heating element 100 is inserted into the aerosol-forming medium and the heating element 100 generates heat to bake the aerosol-forming medium for the insertion of the heating element.

The substrate 10 is of a pin-shaped structure such that when the aerosol-forming medium is heated, the heating element 100 can be facilitated to be inserted into the aerosol-forming medium by the tip of the pin-shaped structure being inserted into the aerosol-forming medium. It may be understood that in some other embodiments, the substrate 10 may further be a sheet-shaped structure, and the specific shape of the substrate 10 is not limited.

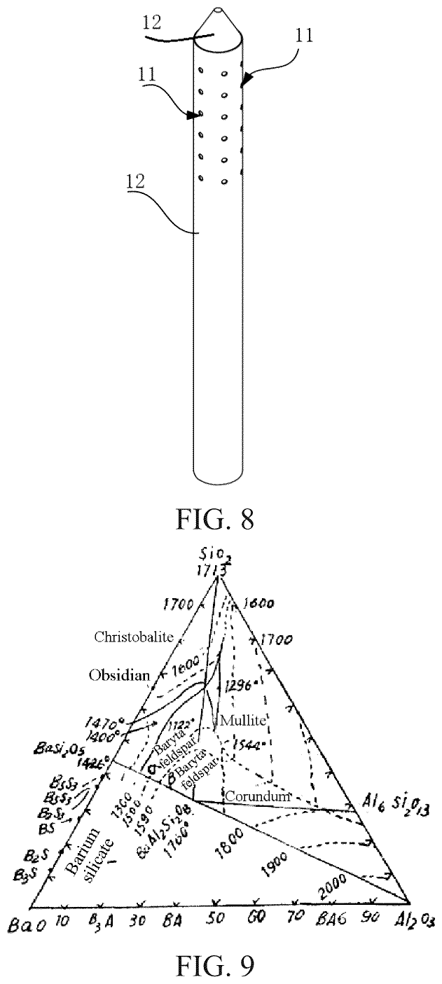

In one embodiment, referring to FIG. 8, the substrate 10 is of a hollow central heating structure with an open end and a closed end, vent holes 11 are formed in the substrate 10, the vent holes 11 are close to the closed end of the substrate 10, and the vent holes 11 enable the hollow part of the substrate 10 to communicate with an external space to form an airflow channel.

Specifically, the substrate 10 includes a top part 12 and a body 13, the body 13 is of a hollow structure with two open ends, the top part 12 is connected with one end of the body 13 in a sealing manner and shields an opening of the end of the body 13, and the vent holes 11 are formed in the body 13 and close to the top part 12.

Generally, the electronic atomization device includes a housing, a heating chamber is formed in the housing, the heating element 100 is partially or all contained in the heating chamber, and the aerosol-forming medium is partially or all contained in the heating chamber. It is found by the research that when the heating element of a conventional low-temperature electronic atomization device is engaged with a housing to heat the aerosol-forming medium, the outside air can only enter the heating chamber from the bottom or the side wall of the housing and then be inhaled away. However, after the heating element is inserted into the aerosol-forming medium, the density of the portion of the aerosol-forming medium close to the heating element is increased, the aerosol-forming medium closer to the heating element easily causes overbaking, and a burnt substance generated by the overbaking is easily inhaled along with an airflow. Besides, the aroma generated by heating the aerosol-forming medium under anoxic condition is mellower. Therefore, in the substrate 10, by forming the vent holes 11 in the area of the body 13 close to the top part 12, the outside air flows into the hollow part of the body 13 and flows into the heating chamber through the vent holes 11 close to the top part 12. The flow path of the airflow is changed and the amount of the burnt substance generated by high-temperature overbaking close to the high-temperature area to be carried away by the airflow is reduced. At the same time, an anoxic environment is given to the aerosol-forming medium close to the bottom of the housing to allow the aerosol-forming medium to generate a mellow aroma, thereby reducing a burnt odor and increasing an aroma, and improving the taste of the aerosol-forming medium after the heating.

Further, the top part 12 is gradually reduced towards the direction far away from the body 13. That is, the cross section of the top part 12 is gradually reduced from one end close to the body 13 to one end for away from the body 13. Such arrangement of the top part 12 may facilitate the insertion of the heating element 100 into the aerosol-forming medium.

Optionally, the body 13 is of a cylindrical structure with two open ends and the top part 12 is tapered.

Specifically, the vent holes 11 close to the top part 12 refers to that the vent holes 11 are formed in the area of the body 13 close to the top part 12. The area is closer to the top part 12 relative to the bottom end of the housing close to the body 13. Optionally, the vent holes 11 are formed in the area of 0 mm-6 mm of the body 13 close to the top part 12. Further, the vent holes 11 are formed in the area of 0 mm-4 mm of the body 13 close to the top part 12.

In one embodiment, multiple vent holes 11 are intervally formed in the body 13. In some other embodiments, only one vent hole 11 may also be formed in the body 13, which is not limited here.

In some embodiments, each vent hole 11 is arranged to be tapered hole and the aperture of the section of each vent hole 11 close to the inner surface of the body 13 is greater than the aperture of the section close to the outer surface of the body 13. Therefore, when the airflow flows out from the hollow part of the body 13 through the vent holes 11, a flow passage is narrowed, such that the airflow flowing out from the body 13 has a larger impact force, and the dirt is less likely to adhere or stick to the outer surface of the body 13, thereby reducing the dirt residue.

In one embodiment, the functional film layer is one or more of a heat-equalizing layer 40, a heating film layer 30, an infrared radiation film layer 50 and a temperature-measuring layer 60 in stacked manner. When electrically energized, the heating film layer 30 generates heat so as to heat the aerosol-forming medium. After the infrared radiation film layer 50 is heated, the aerosol-forming medium is heated by infrared radiation.

The heat-equalizing layer 40 is used for enabling the temperature of each part of the heating element 100 uniform. Specifically, the heat-equalizing layer 40 is used for enabling the temperature of each part of the heating element 100 uniform in the axial and circumferential directions. The temperature-measuring layer 60 is used for measuring the temperature of the heating element 100 to control the temperature of the heating element 100.

In one specific embodiment, referring to FIG. 1, the substrate 10 is of a cylindrical heating structure, the substrate 10 is provided with a containing position for containing an aerosol-forming medium, and the protective layer 20 is arranged on the inner surface and the outer surface of the substrate 10. The functional film layer includes the heat-equalizing layer 40 and the heating film layer 30, the heat-equalizing layer 40 and the heating film layer 30 are both arranged outside the substrate 10, and the heat-equalizing layer 40 is arranged at least a part between the protective layer 20 and the heating film layer 30. Specifically, the heat-equalizing layer 40 is arranged locally between the protective layer 20 and the heating film layer 30. In the present embodiment, the heating film layer 30 is electrically energized to generate heat and transfers the heat to the substrate 10 through the protective layer 20, and to the aerosol-forming medium contained in the containing position. The heat-equalizing layer 40 enables the temperature of each part of the heating element 100 uniform in the circumferential and axial directions, thereby enabling the aerosol-forming medium to be heated uniformly.

In another specific embodiment, referring to FIG. 3, the difference from the last specific embodiment lies in that: the functional film layer further includes the infrared radiation film layer 50, and the infrared radiation film layer 50 is arranged in the substrate 10. Therefore, when the heating film layer 30 heats up to transfer heat to the substrate 10, the substrate 10 transfers the heat to the infrared radiation film layer 50, and the infrared radiation film layer 50 is used for heating the aerosol-forming medium located therein by infrared radiation.

Further, referring to FIG. 3, in order to facilitate the preparation of a heating circuit 32 in the heating film layer 30, the arranged heating film layer 30 includes a first film belt 31 and a heating circuit 32 arranged on the first film belt 31. In this way, when forming the cylindrical heating element 100 or the heating element 100 of another shape, the heating circuit 32 is first printed on the first film belt 31, and then the first film belt 31 on which the heating circuit 32 is printed is made into an adapted shape.

In another specific embodiment, referring to FIG. 4, the substrate 10 is of a cylindrical heating structure, the substrate 10 is provided with a containing position for containing an aerosol-forming medium, and the protective layer 20 is arranged on the inner surface and the outer surface of the substrate 10. The functional film layer includes a temperature-measuring layer 60, the temperature-measuring layer 60 is arranged outside the substrate 10, and the temperature-measuring layer 60 can test the temperature of the heating element 100 so as to control the temperature of the heating element.

In the present specific embodiment, the substrate 10 can inductively generate heat in a magnetic field, a coil may be arranged outside the heating element 100, and the coil is electrically energized to generate the magnetic field, and the heating element 100 is placed in the magnetic field to generate heat.

Further, in order to facilitate the preparation of a temperature-measuring circuit 62 in the temperature-measuring layer 60, the temperature-measuring layer includes a second film belt 61 and a temperature-measuring circuit 62 on the second film belt 61. In this way, when forming the cylindrical heating element 100 or the heating element 100 of another shape, the temperature-measuring circuit 62 is first printed on the second film belt 61, and then the second film belt 61 on which the temperature-measuring circuit 62 is printed is made into an adapted shape.

It should be noted here that, in some other embodiments, when the substrate 10 or the heating element 100 is arranged in other shapes, the functional film layer may be selected and arranged as described in the above specific embodiments, or may be arranged in other manners, which is not limited in detail herein.

In one embodiment, the protective layer 20 is prepared by using a dip-coating process. An object to be coated is completely dipped in a tank containing a coating, taken out of the tank after a short time, and the excess coating liquid is recirculated to the tank, a process known as dip-coating. The dip-coating has the characteristics of high production efficiency, simple operation and less coating loss, and is suitable for small hardware parts, steel pipe frames, sheets, equipment with complex structures or electrical insulator materials and the like.

The protective layer 20 is directly covered on the surface of the substrate 10 by the dip-coating process, and can fully wrap the inner surface and the outer surface of the metal substrate 10 with different structures (especially special-shaped structures), namely, realizing 360° full coverage protection.

Of course, in some other embodiments, the protective layer 20 may be formed on the surface of the substrate 10 by other processes, which is not limited herein.

In one embodiment, the thickness of the protective layer 20 is 5 μm-200 μm. Therefore, the protective layer 20 may sufficiently isolate an adverse environment such as the outside air and the salt fog, such that the heating element 100 may tolerate a salt fog test. Besides, the heavy metal element in the metal substrate 10 may be prevented from being separated out and the safety of the aerosol is ensured. At the same time, the thickness of the protective layer 20 is arranged to be 5 μm-200 μm to facilitate various film coating modes such as silk-screen printing, film rolling, film coating and the like on the surface of the protective layer 20. The functional film layer such as the heat-equalizing layer, the infrared radiation layer and the like may also be added outside the protective layer 20, and the performances of the functional film layer are not affected.

It may be understood that in some other embodiments, the protective layer 20 may also be selected according to requirements, which is not limited herein.

In one embodiment, the protective layer 20 is formed by low-temperature sintering on the surface of the substrate 10. Specifically, the protective layer 20 is prepared by adding oxides of iron, cobalt, and nickel to a glass-forming system. The glass-forming system is a glass-forming framework component.

The 430 stainless steel is taken as an example for illustration, but the protection scope of the present application is not limited by the illustration.

The thermal expansion coefficient of the glass-forming system is matched with that of the stainless steel substrate 10. By adding the oxides of the iron, the cobalt, and the nickel into the glass-forming system, the wettability of the protective layer 20 and the stainless steel substrate 10 may be improved. In the sintering process, the elements may form chemical bond binding with the stainless steel substrate 10 so as to improve the binding strength of the protective layer 20 and the substrate 10. Therefore, the protective layer 20 is prepared by adding the oxides of the iron, the cobalt and the nickel into the glass-forming system. The matching of the thermal expansion of the protective layer 20 and the substrate 10 is relatively high, the binding strength of the protective layer 20 and the substrate 10 may be improved, and the mechanical impact resistance and the thermal impact resistance of the heating element 100 are improved.

Based on the requirement of the thermal expansion matching of the protective layer 20 and the substrate 10, an alternative glass-forming system is a BaO-Al2O3-SiO2 system, or a system of CaO replacing part of BaO in the BaO-Al2O3-SiO2 system is selected. Co2O3 may be added into the oxides of the iron, the cobalt and the nickel.

Further, the BaO-Al2O3-SiO2 system includes a BaO-Al2O3-SiO2 base material, a nucleation agent, an alkali metal oxide, an alkaline earth metal oxide and B2O3. Specifically, the nucleation agent is one or more of TiO2, ZrO2, CaF2, etc.

The alkali metal oxide and the alkaline earth metal oxide regulate the properties of glass and include Na2O, K2O, CaO, MgO, BaO, Al2O3, ZnO, etc. The B2O3 lowers the melting temperature of the glass and adjusts the softening temperature of the glass.

In one specific embodiment, the system includes 75%-95% of the BaO-Al2O3-SiO2 base material, 1%-5% of the nucleation agent, 0.5%-5% of oxides of iron, cobalt and nickel, 3%-10% of the alkali metal oxide and the alkaline earth metal oxide, and 0%-10% of the B2O3. Specifically, referring to FIG. 9, according to the ternary phase diagram of the BaO-Al2O3-SiO2,the main composition ratio of the BaO-Al2O3-SiO2 base material may be selected near a barium feldspar region. The BaO-Al2O3-SiO2 base material includes: 30%-60% of BaO, 10%-30% of Al2O3 and 15%-50% of SiO2. Therefore, the matching of the thermal expansion of the protective layer 20 and the substrate 10 is ensured. At the same time, the binding strength of the protective layer 20 and the substrate 10 may be improved, and the mechanical impact resistance and the thermal impact resistance of the heating element 100 are improved.

When the materials are selected, the low-temperature sintering temperature of the materials and the substrate 10 is 800° C.-900° C. The binding strength of the formed protective layer 20 and the substrate 10 may be ensured. Besides, the protective layer may endure a shock cooling test of room temperature water at 350° C. and may subjected to a long-time cycle test of 20-s heating to 350° C. and then cooling for 1 min for 8,000 times.

In one specific embodiment, the ratios of the materials selected for preparing the protective layer 20 are specifically as follows: 50% of BaO, 15% of Al2O3, 22% of SiO2, 3.5% of ZrO2, 1.5% of TiO2, 1.3% of Na2O, 1.3% of CaO, 1% of MgO, 3% of B203 and 1.4% of Co2O3. The peak crystallization temperature is about 850° C. and the coefficient of thermal expansion is about 10.1 ppm/° C., and the protective layer 20 may be well matched to the 430 stainless steel substrate 10.

In another specific embodiment, the ratios of the materials selected for preparing the protective layer 20 are specifically as follows: 53% of BaO, 14% of Al2O3, 24% of SiO2, 1.8% of ZrO2, 2% of TiO2, 1.3% of K2O, 1.0% of Na20, 0.5% of CaO, 1% of MgO and 1.4% of Co2O3. The peak crystallization temperature is about 860° C. and the coefficient of thermal expansion is about 10.6 ppm/° C., and the protective layer 20 may be well matched to the 430 stainless steel substrate 10.

It is contemplated that in some other embodiments, the types of materials selected for the protective layer 20 may be arranged according to requirements, which is not limited herein.

Another embodiment of the present application further provides a heating element 100. The heating element 100 includes a substrate 10 and a protective layer 20. The substrate 10 is prepared from a metal material. The protective layer 20 directly and completely wraps the surface of the substrate 10 so as to prevent a heavy metal element in the substrate 10 from being separated out.

The present application provides a heating element 100 and an electronic atomization device and has the following beneficial effects:
1. The protective layer 20 is directly arranged on the surface of the substrate 10 and completely wraps the surface of the substrate 10, such that the separating-out of the heavy metal element in the substrate 10 may be prevented in an all-round manner. Since the heavy metal element is not separated from the substrate 10, the safety of an aerosol formed by heating the heavy metal element is guaranteed, such that the human health is protected.
2. The arrangement of the protective layer 20 does not affect the performances of other functional film layers and the protective layer may be continuously coated. Besides, since the protective layer 20 is directly arranged on the surface of the substrate 10, other functional film layers of the heating element 100 must be arranged outside the protective layer 20, thereby avoiding making the salt fog-resistant ability of the heating element 100 weaken greatly by directly coating the functional film layers on the surface of the substrate 10 through high-temperature sintering (the high-temperature sintering is needed when the surface of the substrate 10 is coated, but the protective layer on the surface of the substrate 10 is damaged by a high-temperature heat treatment, an oxide layer is generated, and the corrosion is accelerated in a salt fog environment).
3. The functional film layer of the heating element 100 includes the heating film layer 30. When electrically energized, the heating film layer 30 generates heat so as to heat the aerosol-forming medium to realize heating in the manner of resistance heating. The functional film layer further includes the infrared radiation film layer 50. After the infrared radiation film layer 50 is heated, the aerosol-forming medium is heated by infrared radiation to realize heating in the manner of infrared radiation. The coil may be further arranged outside the heating element 100 to realize heating in the manner of electromagnetic heating. That is, the heating element 100 may selectively select a plurality of heating methods to heat the aerosol-forming medium by changing the implementation of the functional film layer.
4. The protective layer 20 is prepared by adding the oxides of the iron, the cobalt, and the nickel to the glass-forming system. Therefore, the matching of the thermal expansion of the protective layer 20 and the substrate 10 is relatively high. The binding strength of the protective layer 20 and the substrate 10 may be improved, the protective layer 20 is not easy to fall off from the substrate 10, and the mechanical impact resistance and the thermal impact resistance of the heating element 100 are improved.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in the present description.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating element, comprising:
a substrate comprising a metal material; and
a protective layer directly and completely wrapping a surface of the substrate so as to prevent a heavy metal element in the substrate from being separated out.

2. The heating element of claim 1, further comprising:
a functional film layer,
wherein the protective layer is arranged between the functional film layer and the substrate, and
wherein the functional film layer comprises at least one of a heat-equalizing layer, a heating film layer, an infrared radiation film layer, and a temperature-measuring layer.

3. The heating element of claim 2, wherein heating film layer comprises a first film belt and a heating circuit arranged on the first film belt.

4. The heating element of claim 3, wherein the temperature-measuring layer comprises a second film belt and a temperature-measuring circuit arranged on the second film belt.

5. The heating element of claim 2, wherein the substrate comprises a cylindrical heating structure,
wherein the substrate is provided with a containing position configured to contain an aerosol-forming medium,
wherein the protective layer is arranged on an inner surface and an outer surface of the substrate,
wherein the functional film layer comprises the heat-equalizing layer and the heating film layer,
wherein the heat-equalizing layer and the heating film layer are both arranged outside the substrate, and
wherein the heat-equalizing layer is arranged at least partly between the heating film layer and the protective layer.

6. The heating element of claim 5, wherein the functional film layer comprises the infrared radiation film layer, and
wherein the infrared radiation film layer is arranged in the substrate.

7. The heating element of claim 2, wherein the substrate comprises a cylindrical heating structure,
wherein the substrate is provided with a containing position configured to contain an aerosol-forming medium,
wherein the protective layer is arranged on an inner surface and an outer surface of the substrate,
wherein the functional film layer comprises the temperature-measuring layer, and
wherein the temperature-measuring layer is arranged outside the substrate.

8. The heating element of claim 1, wherein the protective layer is prepared using a dip-coating process.

9. The heating element of claim 8, wherein a thickness of the protective layer is 5 μm to 200 μm.

10. The heating element of claim 1, wherein the substrate comprises at least one of 430 stainless steel, 316L stainless steel, and 304 stainless steel.

11. The heating element of claim 1, wherein the substrate comprises a central heating structure, and the protective layer is arranged on an outer surface of the substrate, or
wherein the substrate comprises a peripheral heating structure, the protective layer is arranged on an inner surface and an outer surface of the substrate, and the substrate is provided with a containing position configured to contain an aerosol-forming medium.

12. The heating element of claim 11, wherein the substrate comprises a pin-shaped structure or a sheet-shaped structure, or
wherein the substrate comprises a circular tube structure with two open ends, or a cylindrical structure with an open top end and a closed bottom end.

13. The heating element of claim 11, wherein the substrate comprises a hollow central heating structure with an open end and a closed end,
wherein vent holes are formed in the substrate,
wherein the vent holes are close to the closed end of the substrate, and
wherein the vent holes are configured to enable a hollow part of the substrate to communicate with an external space to form an airflow channel.

14. The heating element of claim 13, wherein the substrate comprises a top part and a body,
wherein the body comprises a hollow structure with two open ends,
wherein the top part is connected with one end of the body in a sealing manner and shields an opening of the end of the body, and
wherein the vent holes are formed in the body and close to the top part.

15. The heating element of claim 14, wherein the body comprises a cylindrical structure, and
wherein the top part is reduced towards a direction away from the body.

16. The heating element of claim 1, wherein the substrate is configured for induction heating in a magnetic field.

17. An electronic atomization device, comprising:
a heating chamber; and
the heating element of claim 1,
wherein the heat element is arranged in the heating chamber and the heating chamber is configured to contain an aerosol-forming medium.
